(19) United States
(12) Patent Application Publication
(10) Pub. No.: US 2025/0376227 A1
(43) Pub. Date: Dec. 11, 2025

(54) SYSTEM FOR AUTOMATICALLY ASSEMBLING VEHICLE INSULATOR AND METHOD THEREFOR

(71) Applicants: Hyundai Motor Company, Seoul (KR); Kia Corporation, Seoul (KR)

(72) Inventor: Ji Hye IM, Suwon-si, Gyeonggi-do (KR)

(73) Assignees: Hyundai Motor Company, Seoul (KR); Kia Corporation, Seoul (KR)

(21) Appl. No.: 18/859,254

(22) PCT Filed: Dec. 20, 2022
(86) PCT No.: PCT/KR2022/020777

§ 371 Date: Aug. 13, 2025

(30) Foreign Application Priority Data
May 2, 2022 (KR) 10-2022-0054303

(51) Int. Cl. B62D 65/02; B25J 15/06; B60R 13/08

(52) U.S. Cl. CPC B62D 65/028; B25J 15/0616; B60R 13/0815

(57) ABSTRACT

The present invention relates to a system for automatically assembling a vehicle insulator, the system comprising: a gripper provided with a guide pin, a fastener coupling part, and a vacuum suction part for extracting an insulator loaded in a supply unit; an assembly robot for assembling the insulator to a lower panel of a vehicle; and a controller which moves the gripper to insert a guide pin into a fixing groove of the loaded insulator and fix the fastener coupling part to a fastener of the insulator, moves the gripper toward the lower panel of the vehicle in a state in which the insulator is fixed to the gripper by the vacuum suction part, and controls the assembly robot to assemble the insulator to the lower panel of the vehicle in a state in which the insulator is supported by the gripper.

### TECHNICAL FIELD

The present disclosure relates to an automated vehicle insulator assembly system and method and, more particularly, to an automated vehicle insulator assembly system and method in which a system for attaching an insulator to the lower panel of a vehicle may be provided as an automated assembly system to replace a conventional system in which an assembly operation is performed manually by a mechanic, thereby improving worker safety and processability.

### BACKGROUND ART

A rear insulator mounted on the underside of a vehicle acts as a sound absorber to block heat and vibration from the vehicle, and is one of the essential parts of the vehicle to provide thermal insulation, dustproofing, and electrical insulation functions to the vehicle.

Conventionally, an operation of attaching a rear insulator to a vehicle is performed manually by a mechanic or worker. Although the rear insulator itself is lightweight, the attachment position is below the vehicle body, and therefore it is necessary to raise the vehicle body to at least a predetermined height to create a working space.

Accordingly, workers must work below the vehicle body to attach the rear insulator to the vehicle body, which may create a constant safety risk and may cause musculoskeletal disorders due to the uncomfortable working posture.

Recently, there has been demand for a solution to reduce the risk of accidents to workers and to reduce the number of workers by establishing an automated system for assembling rear insulators of vehicles using robots. A prior art of this solution is KR 10-2341477 A.

The foregoing is intended merely to aid in the understanding of the background of the present disclosure, and is not intended to mean that the present disclosure falls within the purview of the related art that is already known to those skilled in the art.

### DISCLOSURE

### Technical Problem

The present disclosure is intended to provide an automated vehicle insulator assembly system and method in which a system for attaching an insulator to the lower panel of a vehicle may be provided as an automated assembly system to replace a conventional system in which an assembly operation is performed manually by a mechanic, thereby improving worker safety and processability.

### Technical Solution

In order to accomplish at least one of the above objectives, the present disclosure provides an automated vehicle insulator assembly system including: a gripper provided with a guide pin, a fastener-engaging portion, and a vacuum suction portion for picking up an insulator loaded on a supply unit; an assembly robot configured to attaching the insulator to a lower panel of a vehicle; and a controller configured to move the gripper so that the guide pin is inserted into a fixing hole of the loaded insulator and the fastener-engaging portion engages with a fastener of the insulator, to move the gripper toward the lower panel of the vehicle in a state in which the insulator is held on the gripper by the vacuum suction portion, and to control the assembly robot to attach the insulator to the lower panel of the vehicle in a state in which the insulator is supported on the gripper.

When the loaded insulator has different fixing hole positions depending on vehicle type, the guide pin may be inserted into the fixing hole of the loaded insulator at different positions depending on the vehicle type.

The guide pin may be extended toward the insulator and inserted into the fixing hole of the loaded insulator.

The automated vehicle insulator assembly system may further include a vision measuring device configured to measure a position deviation of the lower panel of the vehicle and the insulator and to transmit measured position correction values to the assembly robot. The vision measuring device may be attached to an end portion of the assembly robot.

When the measured position correction values are transmitted to the assembly robot, the controller may control the assembly robot to adjust the position of the insulator based on the measured position correction values and to attach the insulator to the lower panel of the vehicle.

The automated vehicle insulator assembly system may further include a rack pinion configured to control gripping and rotating motion of the fastener-engaging portion. The controller may control the rack pinion to rotate the fastener-engaging portion that has gripped the fastener of the insulator so that the fastener-engaging portion engages with the fastener.

The automated vehicle insulator assembly system may further include a clamp configured to hold or press the gripper and the insulator by clamping with a clamp-engaging portion for the insulator. In a state where the insulator is held on the gripper, the controller clamp configured control the clamp to be clamped with the clamp-engaging portion for the insulator and to move the insulator toward the lower panel of the vehicle.

In a state where the clamp is clamped with the clamp-engaging portion for the insulator, the controller may move the gripper toward the lower panel of the vehicle and controls the assembly robot to press the insulator toward the lower panel of the vehicle so that the insulator is attached to the lower panel of the vehicle.

The gripper may be attached to an end portion of the assembly robot.

In order to accomplish at least one of the above objectives, the present disclosure provides an automated vehicle insulator assembly method including: moving, by a controller, a gripper so that a guide pin is inserted into a fixing hole of a loaded insulator; controlling, by the controller, a fastener-engaging portion to engage with a fastener of the insulator and a vacuum suction portion to hold the insulator on the gripper, moving, by the controller, the gripper toward a lower panel of a vehicle; and controlling, by the controller, an assembly robot to attach the insulator to the lower panel of the vehicle in a state in which the insulator is supported on the gripper.

The automated vehicle insulator assembly method may further include, prior to inserting the guide pin into the fixing hole of a loaded insulator, measuring, by a vision measuring device, a position deviation of the lower panel of the vehicle and the insulator and transmitting measured position correction values to the assembly robot.

The automated vehicle insulator assembly method may further include, after holding the insulator on the gripper by the vacuum suction portion, holding, by the controller, the gripper and the insulator by clamping the clamp with a clamp-engaging portion for the insulator.

The operation of attaching, by the controller, the insulator to the lower panel of the vehicle may include controlling the assembly robot to press the insulator toward the lower panel of the vehicle so that the insulator is attached to the lower panel of the vehicle.

The operation of controlling, by the controller, the fastener-engaging portion to engage with the fastener of the insulator may include controlling a rack pinion to rotate the fastener-engaging portion that has gripped the fastener of the insulator so that the fastener-engaging portion engages with the fastener.

### Advantageous Effects

According to the automated vehicle insulator assembly system and method of the present disclosure, a system for attaching an insulator to the lower panel of a vehicle may be provided as an automated assembly system to replace a conventional system in which an assembly operation is performed manually by a mechanic, thereby improving worker safety and processability.

The effects of the present disclosure are not limited to the aforementioned description, and other effects of the present disclosure not explicitly described will be clearly understood from the description provided hereinafter by a person having ordinary skill in the technical field, to which the present disclosure pertains.

### DESCRIPTION OF DRAWINGS

FIG. 1 illustrates the configuration of an automated vehicle insulator assembly system according to an embodiment of the present disclosure.

FIG. 2 specifically illustrates the gripper of the automated vehicle insulator assembly system.

FIG. 3 illustrates the insulator clamp attachment to which the clamp of the automated vehicle insulator assembly system is fastened.

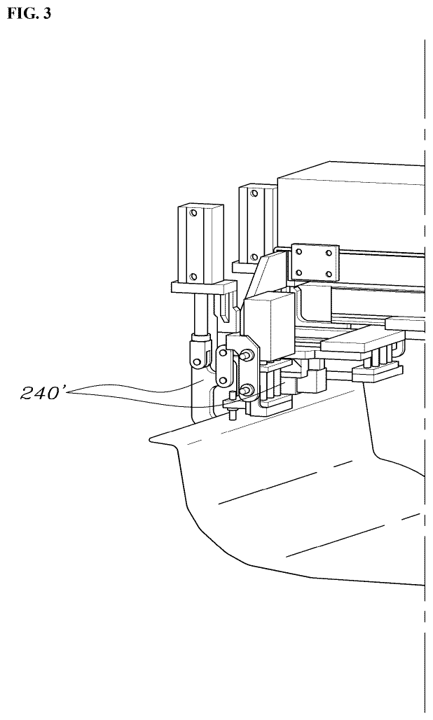

FIG. 4 illustrates the fastener of the insulator with which the fastener attachment of the automated vehicle insulator assembly system is engaged.

FIG. 5 illustrates the rack-pinion configured to control the gripping and rotating motion of the fastener attachment of the automated vehicle insulator assembly system.

FIG. 6 is a flowchart illustrating the operation the automated vehicle insulator assembly system of FIG. 1.

### MODE FOR INVENTION

Specific structural and functional descriptions of embodiments of the present disclosure disclosed herein are only for illustrative purposes of the embodiments of the present disclosure. The present disclosure may be embodied in many different forms without departing from the spirit and significant characteristics of the present disclosure. Therefore, the embodiments of the present disclosure are disclosed only for illustrative purposes and should not be construed as limiting the present disclosure.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

Unless otherwise defined, all terms including technical and scientific terms used herein have the same meaning as commonly understood by a person having ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments disclosed in the present disclosure will be described in detail with reference to the accompanying drawings, in which identical or similar constituent elements are given the same reference numerals regardless of the reference numerals of the drawings, and a repeated description thereof will be omitted. Terms “module” and “part” used in the following description are given or mixed together only for ease of writing the specification, and have no meanings or roles distinct from each other. In addition, in the description of the present disclosure, when it is determined that the detailed description of the related art would obscure the gist of the present disclosure, the detailed description thereof will be omitted. In addition, the attached drawings are merely intended to be able to readily understand the embodiments disclosed herein, and thus the technical idea disclosed herein is not limited by the attached drawings, and it should be understood to include all changes, equivalents, and substitutions included in the idea and technical scope of the present disclosure.

It will be understood that, although terms “first”, “second”, etc., may be used herein to describe various elements, these elements should not be limited by these terms. These terms are only used to distinguish one element from another element.

It will be understood that when an element is referred to as being “coupled”, “connected”, or “linked” to another element, it can be directly coupled or connected to the other element or intervening elements may be present therebetween. In contrast, it should be understood that when an element is referred to as being “directly coupled”, “directly connected”, or “directly linked” to another element, there are no intervening elements present.

As used herein, a singular form is intended to include the plural form as well, unless the context clearly indicates otherwise.

It will be further understood that terms “comprise”, “include”, “have”, etc., when used in the specification, specify the presence of stated features, integers, steps, operations, elements, components, and/or combinations thereof but do not preclude the presence or addition of one or more other features, integers, steps, operations, elements, components, and/or combinations thereof.

According to an embodiment of the present disclosure, in an automated vehicle insulator assembly system, an assembly robot configured to attach an insulator to a lower panel of a vehicle, together with a gripper for gripping the insulator, is proposed to replace the conventional manual insulator assembly method in order to improve worker safety and workability.

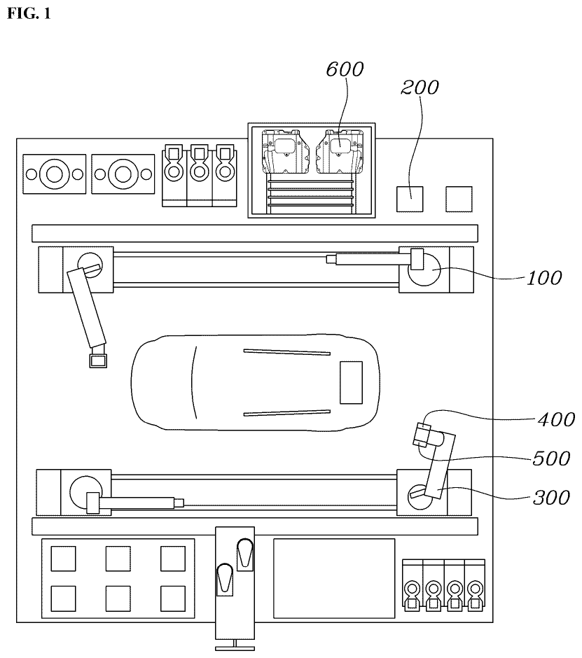

FIG. 1 illustrates the configuration of an automated vehicle insulator assembly system according to an embodiment of the present disclosure. FIG. 1 primarily illustrates components associated with the present embodiment, although actual vehicle implementations may include fewer or more components.

Referring to FIG. 1, a pallet 600 of the automated vehicle insulator assembly system may be loaded with insulators, and may serve to supply parts by aligning the parts so that the insulators are easy to be held by the gripper 200. As used herein, the insulator refers to a rear insulator that is attached to the lower panel of a vehicle, but this is exemplary and not necessarily limiting. The insulator may refer to an insulator attached at a different position.

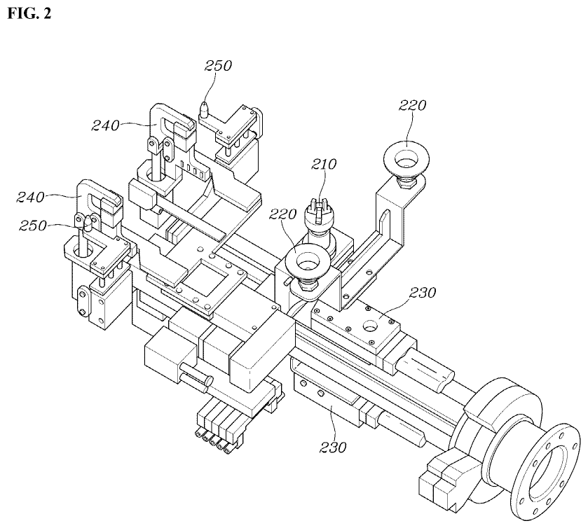

The gripper 200 may grip and hold insulators loaded on the pallet 600, and includes guide pins 250, a fastener-engaging portion 210, and vacuum suction portions 220 for removing insulators loaded on a supply device. The gripper 200 is shown in detail in FIG. 2, and will be described later.

Assembly robots may serve to attach the insulator to the lower panel of the vehicle, and may include both mounting robots 100 and fastening robots 300, as shown in FIG. 1, but are not limited thereto.

Assuming that the mounting robots 100 have a different role from the fastening robots 300, each of the mounting robots 100 may have the gripper 200 attached to the arm end portion thereof and may mount and temporarily fasten the insulator by receiving and correcting the position coordinate values from a vision measuring device 400, and each of the fastening robots 300 may have the vision measuring device 400 attached thereto and may serve to assist the vision measurement for the mounting of the insulator and the position correction of the engaging portion.

In addition, as shown in FIG. 1, the vision measuring device 400 may be attached to the end portion of the assembly robot, and may measure the lower panel and insulator of the vehicle using a vision camera. Specifically, the vision measuring device 400 may measure a position deviation of the insulator and the lower panel of the vehicle and transmit position correction values for the measured position to the assembly robot. When the position correction values measured by the vision measuring device 400 are transmitted to the assembly robot, the assembly robot checks a position to which the insulator is to be attached using the data. After the assembly robot checks the attachment position, the control unit controls the assembly robot to adjust the position of the insulator based on the measured position correction values and attach the insulator to the lower panel of the vehicle. In other words, by setting the insulator in the correct position based on the position correction values, the assembly robot places the insulator in position on the lower panel of the vehicle and attaches the insulator to the lower panel of the vehicle by inserting parts.

In addition, as shown in FIG. 1, a fastening runner 500 receives information values of the fastener-engaging portion 210 from the vision measuring device 400 and fastens a fastener 210′ using a runner configured as a 3-JAW type at the corresponding position and rotates the fastener 210′ by 190 degrees, as will be described later.

A controller may control the gripper 200, the mounting robot 100, the fastening robot 300, and the vision measuring device 400 shown in FIG. 1. In the case of gripping the insulator loaded on the pallet 600, the controller may move the gripper 200 so that the guide pins 250 are inserted into fixing holes of the loaded insulator, control the fastener-engaging portion 210 to engage with the fastener 210′ of the insulator, and fix the insulator to the gripper 200 using the vacuum suction portions 220.

In addition, when attaching the insulator to the lower panel of the vehicle, the controller may move the gripper 200 toward the lower panel of the vehicle and control the assembly robot to attach the insulator to the lower panel of the vehicle while the insulator is supported by the gripper 200.

Hereinafter, a method of fixing the gripper 200 of the automated vehicle insulator assembly system to the insulator will be described with reference to FIG. 2.

FIG. 2 specifically illustrates the gripper 200 of the automated vehicle insulator assembly system.

Specifically, there are four points at which the gripper 200 fixes the insulator, which may be divided into the guide pins 250, the fastener-engaging portion 210, the vacuum suction portions 220, and clamps 240. The gripper 200 is attached to the end portion of the assembly robot to hold the insulator to facilitate the attachment of the insulator to the lower panel of the vehicle. The position of the gripper 200 is not limited to the end portion of the assembly robot, and may be attached at various positions.

First, the guide pins 250 will be described. The guide pins 250 serve to move the gripper 200 to the insulator position to grip the insulator for the vehicle when the pallet 600 is detected by the vision measuring device 400 or sensors. The guide pins 250 of the gripper 200 may be inserted into the fixing holes of the loaded insulators to help stabilize the insulator when the insulator is held on the gripper 200 by the fastener-engaging portion 210, the vacuum suction portions 220, and the clamps 240 described later.

The lower panel of the vehicle has different sizes and positions for different types of vehicles. When insulators have fixing holes at different positions depending on the vehicle type, the guide pins 250 may be inserted into the fixing holes of the loaded insulator at different positions depending on the vehicle type. The vision measuring device 400 or sensors may measure the positions at which the guide pins 250 are inserted for different insulators according to the vehicle type, and the guide pins 250 may be inserted by moving vertically or horizontally to match the sizes and positions of the insulators according to the vehicle type.

In addition, to ensure that the guide pins 250 are accurately inserted into the insulators, the guide pins 250 must be extended toward the insulators and inserted into the fixing holes of the loaded insulators.

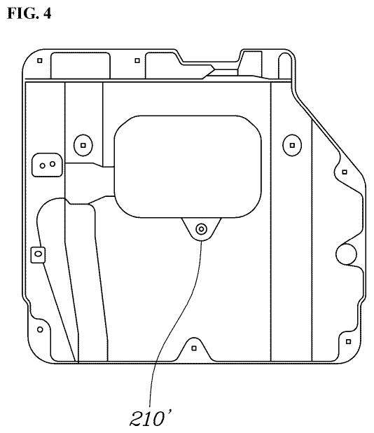

Second, the fastener-engaging portion 210 engages with the fastener 210′ of the insulator. Referring to FIG. 4, the fastener 210′ of the insulator is shown, with which the fastener-engaging portion 210 of the automated vehicle insulator assembly system engages.

The fastener-engaging portion 210 is a 3-JAW type, and may be fastened to the fastener 210′ by rotating 190 degrees after temporary fastening of the fastener 210′. The type of the fastener-engaging portion 210 is not limited to the 3-JAW type.

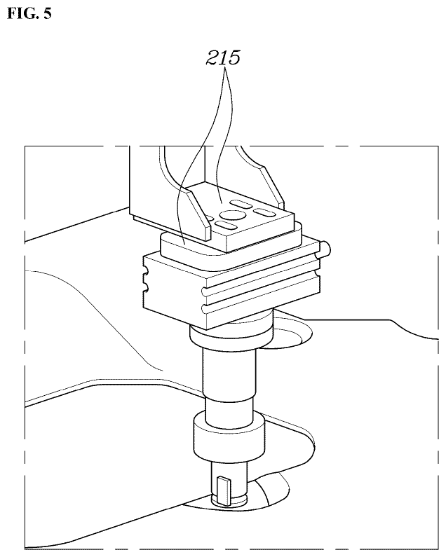

In this case, the fastener-engaging portion 210 is capable of rotating motion and gripping motion using a rack-pinion 215, which may be temporarily fastened to the fastener 210′. FIG. 5 illustrates the rack-pinion 215 configured to control the gripping and rotating motion of the fastener-engaging portion 210 of the automated vehicle insulator assembly system. Referring to FIG. 5, the rack pinion 215 may control the gripping and rotating motion of the fastener-engaging portion 210. Accordingly, the controller may control the rack pinion 215 to rotate the fastener-engaging portion 210 that has gripped the fastener 210′ of the insulator so that the fastener-engaging portion 210 engages with the fastener 210′.

Third, the vacuum suction portions 220 may hold the insulator on the gripper 200 while the fastener-engaging portion 210 is engaged with the fastener 210′ of the insulator. In order for the gripper 200 to hold the insulator, it must be able to suction air, thereby allowing the assembly robot to attach the insulator to the lower panel of the vehicle.

Accordingly, a near-vacuum condition may be created by suctioning air by the vacuum generator 230, thereby allowing the insulator to be held on the gripper 200. As a result, the insulator may be held on the gripper 200 without being damaged by the suction method. The method of holding the insulator using the vacuum suction portions 220 described above is merely illustrative and is not intended to be limiting. It will be apparent to those skilled in the art that various modifications are possible.

Finally, the clamps 240 may serve to hold or press the gripper 200 and the insulator by clamping with insulator clamp-engaging portions 240′. The clamps 240 may clamp a curved portion of the insulator to make the hold be more robust. When the assembly robot attaches the insulator to the lower panel of the vehicle, the clamps 240 may facilitate the attachment operation by pressing the insulator toward the lower panel of the vehicle.

Accordingly, the controller may move the gripper 200 toward the lower panel of the vehicle in a state where the clamps 240 and the clamp-engaging portion 240′ of the insulator are clamped, and control the assembly robot to press the insulator to the lower panel of the vehicle so that the insulator is attached to the lower panel.

In summary, when the position at which the insulator is to be attached to the lower panel of the vehicle is determined by the vision measuring device 400 of the mounting robot 100 or the fastening robot 300, the position correction values measured by the vision measuring device 400 is transmitted to the assembly robot, and the assembly robot checks the attachment position based on the data. When the gripper 200 arrives at the gripping and suction position on the pallet 600, the guide pins 250 are inserted into the fixing holes of the insulator, and the fastener-engaging portion 210 engages with the fastener 210′. In a state where the fastener-engaging portion 210 is engaged with the fastener 210′, air created by the vacuum generator 230 causes the insulator to be held on the gripper 200 by the vacuum suction portions 220.

Thereafter, the clamps 240 are clamped with the insulator clamp-engaging portion 240′ to hold the gripper 200 and the insulators. Thereafter, when the gripper 200 removes the insulator from the pallet 600 and the assembly robot receives the correction values of the attachment position determined by the vision measuring device 400, the assembly robot may locate the insulator on the vehicle at the correct position, and the fastener-engaging portion 210 may fasten the fastener 210′ to a vehicle stud and fix the insulator by rotation. In addition, since the cylinder operates in a direction opposite to the direction in which the guide pin 250 was inserted, the vehicle stud may be inserted into the fixing hole in which the guide pin 250 was inserted.

The clamps 240 may also be released from the clamp-engaging portion 240′, and together with the vacuum suction portions 220, may be pressed and attached to the lower panel of the vehicle in order to fit the stud into another hole of the insulator and tightly contact a component to the vehicle body. Once the vehicle body studs are inserted into the holes of the insulator, the fastening runner 500 fastens the component to complete the operation.

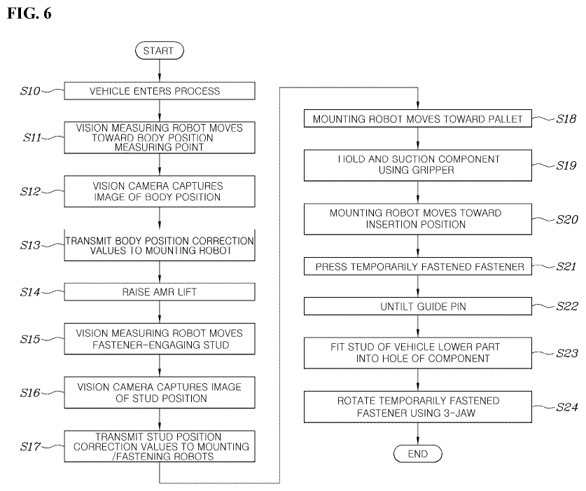

An automated vehicle insulator assembly method according to an embodiment based on the vehicle configuration described above will be described with reference to FIG. 6.

FIG. 6 is a flowchart illustrating the operation the automated vehicle insulator assembly system of FIG. 1.

Referring to FIG. 6, the vehicle enters a process (S10), and the vision measuring device 400 provided on the assembly robot or mounting robot 100 moves to measure the position of the lower panel of the vehicle (S11). When the vision measuring device 400 measures position correction values of the lower panel of the vehicle (S12), the vision measuring device 400 transmits the measured position correction values to the assembly robot, and the assembly robot receives the transmission (S13). At this time, the position correction values of the lower panel of the vehicle is obtained by image capturing by the vision cameras at two L/R positions, i.e., four positions in total, and the vision control PC may transmit the correction values (X, Y, Z, Rx, Ry, Rz) by calculating corresponding coordinate values.

Thereafter, prior to attaching the insulator to the lower panel of the vehicle, the vehicle is raised (S14) using a lift provided on a robot, such as an AMR or AGV, when an operation completion signal is transmitted to the assembly robot. Thereafter, as the lift rises, the assembly robot moves to the lower part of the vehicle and to the positions of the studs to be fitted into the holes of the insulator (S15).

The vision measuring device 400 captures images from at least four stud holes in the underside of the vehicle (S16) and transmits the correction values to the assembly robot (S17). The assembly robot then moves to the pallet 600 to pick up the insulator (S18) and uses the gripper 200 to hold the insulator with suction (S19). As described above, the operation of holding the insulator with suction (S19) may include: moving, by the controller, the gripper 200 to insert the guide pins 250 into the fixing holes of the loaded insulator; controlling, by the controller, the fastener-engaging portion 210 to engage with the fastener 210′ of the insulator and holding the insulator on the gripper 200 using the vacuum suction portions 220; controlling, by the controller, the clamps 240 to be clamped with the insulator clamp-engaging portions 240′ to hold the gripper 200 and the insulator; moving, by the controller, the gripper toward the lower panel side of the vehicle; and controlling, by the controller, the assembly robot to attach the insulator to the lower panel of the vehicle in a state where the insulator is supported by the gripper 200.

Thereafter, the assembly robot loaded with the insulator moves to the insulator attachment position (S20), the fastener-engaging portion 210 engages with the fastener 210′ and presses the fastener 210′ while rotating at least 100 degrees (S21), and the guide pins 250 are released (S22). Subsequently, the stud provided on the lower panel of the vehicle is fitted into the insulator hole (S23), and the remaining fasteners 210′ are fastened and then rotated in the same manner using the fastener-engaging portions 210 of the assembly robot (S24) to complete the operation.

Detailed technical features of the respective steps of the automated vehicle insulator assembly method according to the present disclosure are the same as or similar to the technical features of the respective components of the automated vehicle insulator assembly system according to the present disclosure described above, and therefore a detailed description thereof will be omitted.

In the step of controlling, by the controller, the fastener-engaging portion 210 to engage with the fastener 210′ of the insulator, the controller may control the rack pinion 215 to rotate the fastener-engaging portion 210 that has gripped the fastener 210′ of the insulator so that the fastener-engaging portion 210 engages with the fastener 210′.

As a result, according to the automated vehicle insulator assembly system and method of the present disclosure, a system for attaching an insulator to the lower panel of a vehicle may be provided as an automated assembly system to replace a conventional system in which an assembly operation is performed manually by a mechanic, thereby improving worker safety and processability.

Although the specific embodiments of the present disclosure have been described for illustrative purposes, a person having ordinary skill in the art will appreciate that various modifications, additions, and substitutions are possible, without departing from the scope and spirit of the present disclosure as disclosed in the accompanying claims.

### DESCRIPTION OF THE REFERENCE NUMERALS IN THE DRAWINGS

100: mounting robot
200: gripper
210: fastener-engaging portion
210′: fastener
215: rack pinion
220: vacuum suction portions
230: vacuum generator
240: clamp
240′: clamp-engaging portion
250: guide pin
300: fastening robot
400: vision measuring device
500: fastening runner
600: pallet

1. An automated vehicle insulator assembly system comprising:
a gripper provided with a guide pin, a fastener-engaging portion, and a vacuum suction portion for picking up an insulator loaded on a supply unit;
an assembly robot configured to attaching the insulator to a lower panel of a vehicle; and
a controller configured to move the gripper so that the guide pin is inserted into a fixing hole of the loaded insulator and the fastener-engaging portion engages with a fastener of the insulator, to move the gripper toward the lower panel of the vehicle in a state in which the insulator is held on the gripper by the vacuum suction portion, and to control the assembly robot to attach the insulator to the lower panel of the vehicle in a state in which the insulator is supported on the gripper.

2. The automated vehicle insulator assembly system of claim 1, wherein when the loaded insulator has different fixing hole positions depending on vehicle type, the guide pin is inserted into the fixing hole of the loaded insulator at different positions depending on the vehicle type.

3. The automated vehicle insulator assembly system of claim 1, wherein the guide pin is extended toward the insulator and inserted into the fixing hole of the loaded insulator.

4. The automated vehicle insulator assembly system of claim 1, further comprising a vision measuring device configured to measure a position deviation of the lower panel of the vehicle and the insulator and to transmit measured position correction values to the assembly robot,
wherein the vision measuring device is attached to an end portion of the assembly robot.

5. The automated vehicle insulator assembly system of claim 4, wherein when the measured position correction values are transmitted to the assembly robot, the controller controls the assembly robot to adjust the position of the insulator based on the measured position correction values and to attach the insulator to the lower panel of the vehicle.

6. The automated vehicle insulator assembly system of claim 1, further comprising a rack pinion configured to control gripping and rotating motion of the fastener-engaging portion,
wherein the controller controls the rack pinion to rotate the fastener-engaging portion that has gripped the fastener of the insulator so that the fastener-engaging portion engages with the fastener.

7. The automated vehicle insulator assembly system of claim 1, further comprising a clamp configured to hold or press the gripper and the insulator by clamping with a clamp-engaging portion for the insulator,
wherein in a state where the insulator is held on the gripper, the controller controls the clamp to be clamped with the clamp-engaging portion for the insulator and to move the insulator toward the lower panel of the vehicle.

8. The automated vehicle insulator assembly system of claim 7, wherein in a state where the clamp is clamped with the clamp-engaging portion for the insulator, the controller moves the gripper toward the lower panel of the vehicle and controls the assembly robot to press the insulator toward the lower panel of the vehicle so that the insulator is attached to the lower panel of the vehicle.

9. The automated vehicle insulator assembly system of claim 1, wherein the gripper is attached to an end portion of the assembly robot.

10. An automated vehicle insulator assembly method comprising:
moving, by a controller, a gripper so that a guide pin is inserted into a fixing hole of a loaded insulator;
controlling, by the controller, a fastener-engaging portion to engage with a fastener of the insulator and a vacuum suction portion to hold the insulator on the gripper;
moving, by the controller, the gripper toward a lower panel of a vehicle; and
controlling, by the controller, an assembly robot to attach the insulator to the lower panel of the vehicle in a state in which the insulator is supported on the gripper.

11. The automated vehicle insulator assembly method of claim 10, further comprising, prior to inserting the guide pin into the fixing hole of a loaded insulator,
measuring, by a vision measuring device, a position deviation of the lower panel of the vehicle and the insulator and transmitting measured position correction values to the assembly robot.

12. The automated vehicle insulator assembly method of claim 10, further comprising, after holding the insulator on the gripper by the vacuum suction portion,
holding, by the controller, the gripper and the insulator by clamping the clamp with a clamp-engaging portion for the insulator.

13. The automated vehicle insulator assembly method of claim 12, wherein attaching, by the controller, the insulator to the lower panel of the vehicle comprises controlling the assembly robot to press the insulator toward the lower panel of the vehicle so that the insulator is attached to the lower panel of the vehicle.

14. The automated vehicle insulator assembly method of claim 10, wherein controlling, by the controller, the fastener-engaging portion to engage with the fastener of the insulator comprises controlling a rack pinion to rotate the fastener-engaging portion that has gripped the fastener of the insulator so that the fastener-engaging portion engages with the fastener.
